(19) United States
(12) Patent Application Publication
(10) Pub. No.: US 2018/0293629 A1
(43) Pub. Date: Oct. 11, 2018

(54) Immersive crowdfunding and crowdsourcing system

(71) Applicant: David Joel Roman, Phoenix, AZ (US)

(72) Inventor: David Joel Roman, Phoenix, AZ (US)

(21) Appl. No.: 15/932,486

(22) Filed: Mar. 6, 2018

Related U.S. Application Data
(63) Continuation of application No. 62/600,945, filed on Mar. 6, 2017.

(51) Int. Cl. G06Q 30/02; G06T 19/00; G06Q 10/10; H04L 9/06

(52) U.S. Cl. CPC G06Q 30/0279; G06T 19/006; H04L 2209/38; H04L 9/0637; G06Q 10/101

(57) ABSTRACT

Online support solicitation platform connecting client and server devices with software mechanism allowing users to interact with a virtual object representing a project's goal, preview and select available portions to pledge support while immersed in/interacting with virtual object, directly or alternatively fulfill support pledges, receive corresponding rewards, and view the incremental impact of fulfilled pledges on the virtual object and block chain or any other kind of ledger with secure traceability. Project experience and evaluation may be done by visitors, who can become project contributors. Project may solicit funding and/or any other kind of support and may be updated once or more before project closing as solicitation portions are fulfilled. Project updating may be in acknowledgement of user suggested improvements. Project experience may be enhanced/engaged with artificial intelligence and may involve augmented reality, virtual reality, or any other kind of immersive experience.

### TECHNICAL FIELD

The disclosed embodiments relate generally to the use of online platforms connecting client and server devices to engage multiple users and raise funds or source other forms of project support.

### BACKGROUND

Crowdfunding platforms, volunteer portals, and classified ad websites are well known in the art. Crowdfunding platforms, such as Kickstarter, Indiegogo and others, are becoming more popular for raising awareness and support for new products and services.

However, even state-of-art crowdfunding platforms have drawbacks. Projects can require multiple forms of support (e.g. time, materials, information), not just funding. Ledgers may not distributed/chained. Equities may not be known until the end of a campaign. Many supporters, especially younger generations, may be better engaged by interactive activity like gaming than by more passive content such as infomercials. While well-crafted video commercials and text-based project descriptions may intrigue viewers, support pledge mechanisms can be rigid and non-interactive, making the user feel quite disconnected from the experience of watching video or reading descriptions.

The disclosed embodiments fulfill the need for an online mechanism to showcase and select funding/sourcing options using, in part, digital game technology (e.g. 2D/3D digital animation, augmented/virtual reality) to make crowdfunding and/or crowdsourcing fun, attractive, easy and effective, with continuous and instantaneous pledge fulfillment updates, whereas showcased and selectable digital objects representing project funding/sourcing goals can be displayed in the frontend and experienced or interacted with as virtual products or places or games and portions of residual funding/sourcing opportunities can be grabbed by users as viewers or visitors or players (anonymous to other users) and contributions can be tracked in a distributed ledger (e.g. block chain), while the fundraising and project sourcing management may be done by a backend software, accessible only to project initiators, owners and caretakers, as well as to system administrators.

Despite attempts to improve at least one aspect of the state-of-art crowdfunding platforms, none may adequately meet the need addressed by the disclosed embodiments.

For instance, US 2015/0089353 A1 of Mar. 26, 2015 by Chad Folkening may be only tangentially relevant to crowdfunding for proposing virtual engagement of entity conversions, and it may not feature integrated pledge fulfillment or reward.

Others like US 2014/0067644 A1 of Mar. 6, 2014 by Cameron, et al. may not apply to crowdfunding fractional project portions and may not help for consumer products or other goods sellable online.

US 2016/0335629 A1 of Nov. 17, 2016 by Angus Scott may not be a block chain ledger of public keys, and it may require real, not virtual, exchange agents and issuers.

None of these or other inventors may offer complete practical solutions, which must be capable of crowdsourcing (e.g. soliciting contributions of time, materials, information) as well as crowdfunding (e.g. soliciting investments, donations, purchases). None may provide immersive or interactive experiences, like in a game. None may allow guest players to try out “what if” funding scenarios or allow users to test projects/products in virtual environment anonymously before the projects/products are done/made. None may let users pledge support directly within an embedded immersive experience or fulfill pledges immediately there or soon elsewhere. None may provide additional incentive to support the project by creating a virtual artifact that can be updated with proportional credits to contributors and later showcased (e.g. in museums, public places, websites, corporate venues).

Therefore, the object of the disclosed embodiment is to provide a solution that remedies at least the listed shortcomings of state-of-art crowdfunding systems and platforms. More specifically, to virtually represent the object of current/future products or projects to be crowdfunded/crowdsourced, let users interact with the virtual representation before committing to funding/sourcing, let users explore “what if” funding/sourcing scenarios and observe the impact of such scenarios on the virtual representation, let users immerse themselves in virtual product/project testing, let users support projects by “like it” scores or other means of providing information or opinion, let users pledge funding either anonymously or with credit, let users transfer funds automatically directly or via alias using credit card or bank transfer or sourced item registry update on the ledger (e.g. block chain), let users receive a certificate of funding and/or sourcing, and let users log suggestions for product or project improvements.

### SUMMARY

The above problems and others are at least partially solved and the above objects and others realized in a process, which according to the teachings of the disclosed embodiments, uses an online platform for supporting a project via crowdfunding/crowdsourcing, allowing users to interact with a virtual representation of the project as visitors or contributors in-kind or monetary funds, in whole or in part, while funding and/or sourcing status may be updated and displayed instantly upon change and visitors are allowed to test future products/projects, play “what if” scenarios of potential pledge impacts on the project and post improvement suggestions to the project, which are registered with associated pledges on a ledger such as a block chain.

An example project would be prototyping a three-wheeler two-seater vehicle, which neither a car or a motorcycle, or rather both, in need of parts, labor, and money to collect from pledged donations for which sponsor credit and early booking on production units may be secured with privileges in proportion to the contribution fraction relative to the whole, while the project may update by integrating donor suggestions.

In the frontend, the platform visitor can interact with the model displayed in 3-D virtual reality and the user inputs are fed to the motion, graphic and sound simulator. Upon test-driving the virtual model vehicle, the visitor may post suggestions on improvements or comment on shortcomings.

Should a visitor decide to contribute to the project, he/she may do that by choosing the desired part and portion in the virtual model, authorizing the “pledge” by completing a form or other confirmation embedded in the virtual experience and integrated with the fulfillment mechanism, and signing with electronically verified signature. He/she may pledge money to be withdrawn from his/her credit card or pledge to deliver or let pick up for shipping mechanical or electrical parts or may pledge to work certain hours to advance the project.

The project administrator or a virtual agent powered by artificial intelligence algorithms may interact proactively and reactively with the potential donor by asking/answering questions about the project or parts, adjusting the virtual experience in light of new user inputs, and suggesting viable contributions which suit the donor and the project best.

The donor then pledges donations. The fulfillment mechanism with the administrator and/or virtual agent allocates the pledge, registers it, logs it and certifies it, using a blockchain ledger.

If the project owner agrees, a contributor improvement suggestion on the project may promptly modify the project with the suggested improvement marked as tentative user improvement to further incentivize more improvement suggestions.

Before contributing, a visitor may check, what would be the impact on the project, if he/she would contribute. The project may close once sufficient contributions are registered.

The administrator, via software, defines what portion of the project needs support and assigns a value of to each project fraction so the project can define and meet its goals. He/she also allocates the pledged portions and rewards the contributors in proportion. Rewards may be project/product privileges to be enjoyed after the project/part closes, may be just credit displayed in the virtual model as an artifact showcasing the proportional contributions, or may be in other forms of reciprocity permitted for the project/part. Rewards exclude stakes of ownership of the project/product, but may include first-to-refuse rights at the project owner's discretion.

The administrator may record and post selected outstanding visitor or contributor test-driving videos, and may conduct discussions on suggestions for improvement as a moderated forum embedded in the virtual experience and/or elsewhere in the platform.

The administrator with the fulfillment mechanism manages the financial transactions and may arrange for transportation and warehousing of in-kind contributions, providing reports to authorities and project owners as needed. The administrator may draw his/her fee from the collected funds in agreement with the project owner.

The project ends when its owner terminates it or when the administrator closes it upon reaching stated goals or if authorities request the closing for substantiated reasons.

The administrator works in the backend and his/her interface may not be seen by the visitors/contributors.

In this example, contributions can be anonymous, but suggestions cannot. Visitors may just post “like it” scores, for instance 1, 2, 3, 4 and 5-star ratings, for others to see. Contributions may be pledged by qualifying proxy, be that a person or entity in agreement, which must be declared under oath. The administrator may verify such proxy qualification before registering any proxy contributions.

### BRIEF DESCRIPTION OF THE DRAWINGS

Referring to the drawings:

FIG. 1 is a system diagram of the method as per the teachings of the invention.

FIG. 2A is a process diagram of the frontend part of the online platform as per the teachings of the invention.

FIG. 2B is a process diagram of the backend part of the online platform as per the teachings of the invention

### DESCRIPTION OF EMBODIMENTS

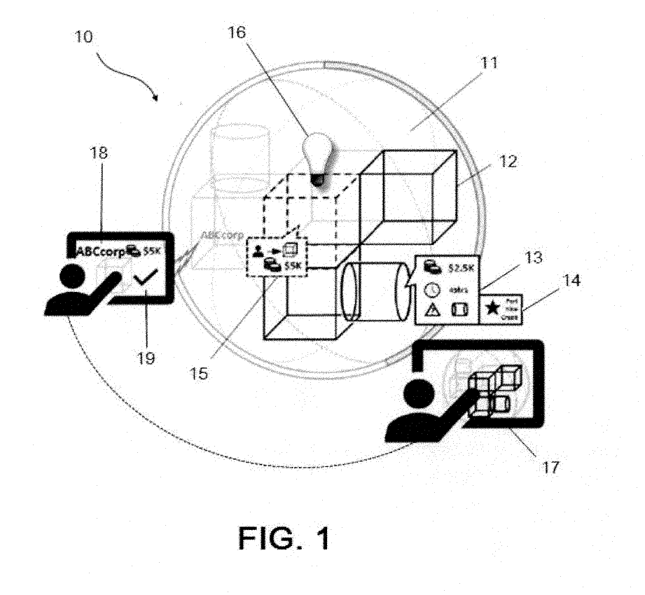

Attention is now turned to FIG. 1, which by system 10, illustrates an example embodiment.

System 10 comprises object 11, part 12, portion 13, reward 14, pledge 15, suggestion 16, visitor 17, contributor 18 and contribution 19.

Object 11 is the virtual representation of the project goal in which users (visitors/contributors) may immerse themselves and interact with the subject of the project to be supported (i.e. funded/sourced by cash or in-kind contributions) for rewards respectively. If a new product to be prototyped, produced and marketed for sale, the reward 14, could be receiving the product at discount before the general public can buy it at full price. The object then could be a 3-D virtual reality tour or test-drive opportunity of the animated/simulated product.

Part 12 is a fraction of the total project support as defined by the system administrator, using a software. As the funding/sourcing progresses on the platform online, the virtual model shows which parts are claimed and which parts remain to be fully funded/sourced. Remaining parts gradually diminish until none are left at which time the project closes.

Portion 13 is the contribution type (e.g. funding, in-kind) and size needed for part 12, as defined by the administrator. This shows visitors what and how much is needed for part 12. The system administrator defines any allowed contribution type/size alternatives to portion 13.

Reward 14 is the reward allocation for portion 13 as defined by the administrator, using a software. The administrator may define at his/her discretion additional reward options for contributions to part 12 that are less than or otherwise different than its standard portion 13 (e.g. awarding title credit for part 12 via majority contribution under/above portion 13 or via auction/bid with or without minimum/maximum limits, with other credits displayed less prominently, proportional to overall part 12 contributions).

Pledge 15 may be the selection of the contribution towards part 12 as a user input per portion 13 or other contribution type/amount. The system administrator may qualify the pledge 15 before acceptance.

Suggestion 16 may be another user input of either visitor 17 or contributor 18. Suggestions by visitor 17 are posted, may be implemented but credit may not be given to the posting visitor. Suggestions by contributor 18 may be implemented before the project closes and marked as provisional improvement with named or anonymous credit posted as requested by contributor 18.

Visitor 17 is interacting with object 11 of the project and may become contributor 18.

Contribution 19 by contributor (project supporter) 18 is allocated, registered, logged and rewarded by the system administrator as fulfillment. The system administrator manages both the monetary and the in-kind contributions and may draw fees from the already pledged and deposited funds in agreement with the project owner.

Once the project is fully funded and/or sourced, the administrator as crowdfunding/crowdsourcing project manager, closes the project, but may leave its history posted to serve as example for other future or ongoing projects.

The platform's frontend and backend functions are explained next.

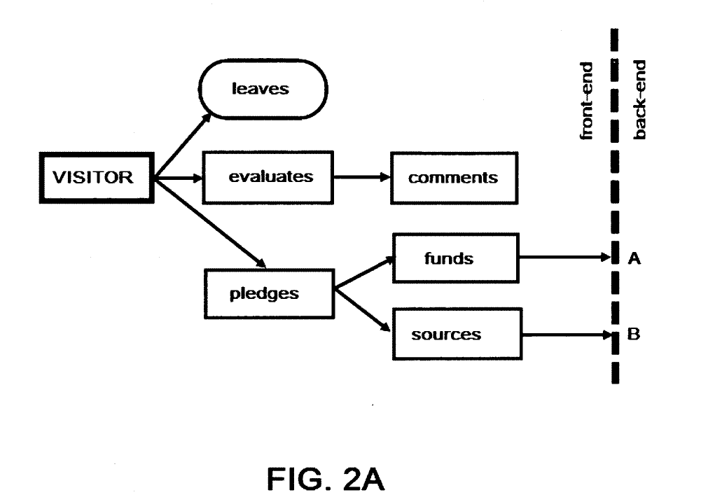

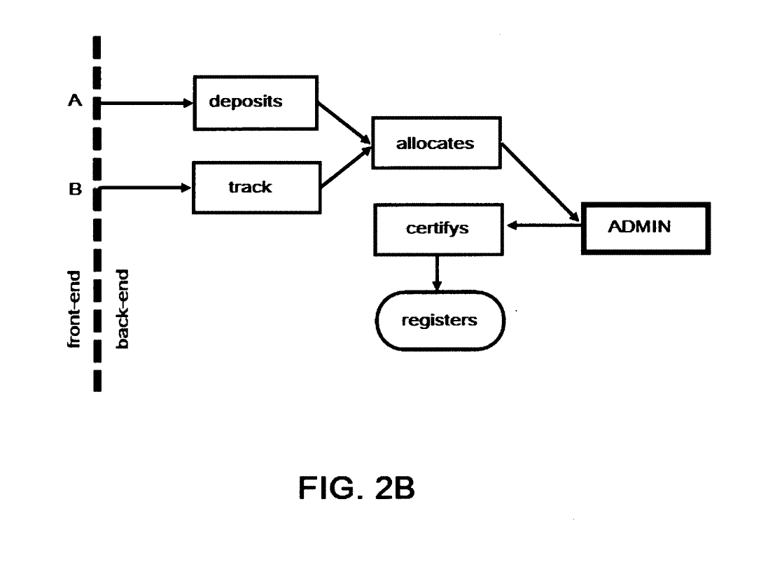

Attention is now turned to FIG. 2A, which is a preferred process diagram of the frontend part of the online platform as per the disclosed embodiments.

Visitor 17 may interact with the virtual model anonymously but must register if becomes contributor 18. After some orientation, he/she may leave without interacting further, if not interested. He/she may evaluate the project by interacting with it and may comment on it in a general comment area or in a particular place/time in the object 11. As contributor 18, he/she may pledge cash or in-kind, that is funds or something else to be sourced (lines A and B correspondingly). That is passed to the platform backend, which is explained next.

Attention is now turned to FIG. 2b, which is an example process diagram of the backend part of the online platform as per the teachings of the disclosed embodiments.

The system administrator (ADMIN) deposits the funds and tracks other sources coming from lines A and B respectively from the frontend. He/she verifies and allocates the pledges and certifies and registers the rewards, all by using a block chain or any other kind of ledger providing secure traceability.

The system administrator can see both the frontend and the backend, but the backend is only visible and accessible to him/her.

Those skilled in the art will recognize that changes may be made in the described embodiment without departing from the nature and scope of the disclosed embodiments. For instance, periodic project update, versus continuous one, which is tied to timelines or milestones, are intuitive and hereby instructive, thus considered being within the scope of the invention.

Various further changes and modifications to the embodiment herein chosen for purposes of illustration will readily occur to those skilled in the art. To the extent that such modifications and variations do not depart from the spirit of the disclosed embodiments, they are intended to be included within the scope thereof.

The foregoing description has explained specific embodiments. However, the illustrative discussions above are not intended to be exhaustive or to limit the invention to the precise forms disclosed. Many modifications and variations are possible in view of the above teachings. The embodiments were chosen and described to explain the principles of the invention and its practical applications, to thereby enable others skilled in the art to best utilize the invention and various embodiments with various modifications as are suited to other specific uses.

What is claimed is:

1. Online project supporting method allowing to immerse in virtual reality object representation for interacting with and thus evaluating projects so represented in solicitation of contributions for rewards with integrated fulfillment management using block chain ledger tracking, whereas said project experience and evaluation is done by visitors, who can become project contributors.

2. Method as per claim 1, for crowdfunding.

3. Method as per claim 2, updated with user suggestions before termination.

4. Method as per claim 2, fragmented to funded and remaining parts and to their corresponding portions and rewards updated once or more before project closing upon being fully funded.

5. Method as per claim 2, allowing visitors to become funding contributors.

6. Method as per claim 1, for crowdsourcing.

7. Method as per claim 6, updated with user suggestions before termination.

8. Method as per claim 6, fragmented to sourced and remaining parts and to their corresponding portions and rewards updated once or more before project closing upon being fully sourced.

9. Method as per claim 6, allowing visitors to become sourcing contributors.

10. Software representing an online platform of a project supporting method, which allows users to immerse in virtual reality object representation for interacting with and thus evaluating projects so represented in solicitation of contributions for rewards with integrated fulfillment management using block chain ledger tracking, whereas said interaction and project evaluation may be done by visitors, who can become project contributors.

11. Software as per claim 10, having a frontend and a backend for users and administrators respectively.

12. Software as per claim 11, whereas said frontend may be accessible to said users and said backend may be only to system administrators.

13. Software as per claim 10, providing users and administrators more interactivity and guidance using artificial intelligence.

14. Software as per claim 10, for crowdfunding.

15. Software as per claim 14, updated with user suggestions before termination.

16. Software as per claim 14, fragmented to funded and remaining parts and to their corresponding portions and rewards updated once or more before project closing upon being fully funded.

17. Software as per claim 14, allowing visitors to become funding contributors.

18. Software as per claim 10, for crowdsourcing.

19. Software as per claim 18, updated with user suggestions before termination.

20. Software as per claim 6, fragmented to sourced and remaining parts and to their corresponding portions and rewards updated once or more before project closing upon being fully sourced.

21. Software as per claim 18, allowing guests to become sourcing contributors.
